(19) United States
(12) Patent Application Publication
(10) Pub. No.: US 2024/0361125 A1
(43) Pub. Date: Oct. 31, 2024

(54) Vibrator Device

(71) Applicant: SEIKO EPSON CORPORATION, Tokyo (JP)

(72) Inventors: Kota KOMATSUBARA, Minamiminowa (JP); Norifumi SHIMIZU, Matsumoto (JP); Seiichiro OGURA, Minowa (JP)

(21) Appl. No.: 18/645,798

(22) Filed: Apr. 25, 2024

(30) Foreign Application Priority Data
Apr. 28, 2023 (JP) 2023-074892

(51) Int. Cl. G01C 19/5656

(52) U.S. Cl. CPC G01C 19/5656

(57) ABSTRACT

A vibrator device includes, when three axes orthogonal to each other are defined as an X-axis, a Y-axis, and a Z-axis, a vibrator element that performs drive vibration in a direction along an X-Y plane defined by the X-axis and the Y-axis, and a support substrate that supports the vibrator element. When fd>fz, 0.05<(fd−fz)/fd<0.9, and when fd<fz, 0.05<(fz−fd)/fd<1, where fd is a frequency of the drive vibration of the vibrator element, and fz is a frequency of a Z-axis vibration mode that is a vibration mode along the Z-axis of the support substrate.

The present application is based on, and claims priority from JP Application Serial Number 2023-074892, filed April 28, 2023, the disclosure of which is hereby incorporated by reference herein in its entirety.

### BACKGROUND

### 1. Technical Field

The present disclosure relates to a vibrator device.

### 2. Related Art

A vibrator device disclosed in JP-A-2021-071370 includes a package having a base and a lid, a support substrate that is accommodated in the package and supported by the base, and a vibrator element that is accommodated in the package and supported by the support substrate. The vibrator element is an angular velocity detector element that detects an angular velocity around a Z-axis in a thickness direction thereof.

In such a vibrator device, when a frequency of a Z-axis vibration mode that is a mode of vibration in the thickness direction of the support substrate, that is, in the Z-axis direction, approaches a drive frequency of the vibrator element, the Z-axis vibration mode is excited in the support substrate by the drive vibration of the vibrator element. Then, there is a possibility that the vibration due to the Z-axis vibration mode leaks out of the package and such leakage vibration is reflected by a mounting destination and interferes with the vibrator element. As described above, when the leakage vibration interferes with the vibrator element, the vibration state of the vibrator element varies, and the stability of the stationary-state output deteriorates.

### SUMMARY

A vibrator device according to an aspect of the present disclosure includes, when three axes orthogonal to each other are defined as an X-axis, a Y-axis, and a Z-axis:
a vibrator element that performs drive vibration in a direction along an X-Y plane defined by the X-axis and the Y-axis; and
a support substrate that supports the vibrator element, in which
when fd>fz, 0.05<(fd−fz)/fd<0.9, and
when fd<fz, 0.05<(fz−fd)/fd<1,
where fd is a frequency of the drive vibration of the vibrator element, and fz is a frequency of a Z-axis vibration mode that is a vibration mode along the Z-axis of the support substrate.

### BRIEF DESCRIPTION OF THE DRAWINGS

FIG. 1 is a cross-sectional view of a vibrator device according to a preferred embodiment.

FIG. 2 is a top view of an angular velocity detector element of the vibrator device.

FIG. 3 is a schematic diagram showing drive vibration of the angular velocity detector element.

FIG. 4 is a schematic diagram showing detection vibration of the angular velocity detector element.

FIG. 5 is a top view of a support substrate of the vibrator device.

FIG. 6 is a view showing a mounting state of the vibrator device.

FIG. 7 is a graph showing a relationship between a frequency fd of drive vibration and a frequency fz of a Z-axis vibration mode.

FIG. 8 is a graph showing a relationship between a frequency fd of drive vibration and a frequency fz of a Z-axis vibration mode.

FIG. 9 is a cross-sectional view of a socket substrate for experiment.

FIG. 10 is a table showing experimental results.

### DESCRIPTION OF EMBODIMENTS

Hereinafter, a vibrator device according to an embodiment of the present disclosure will be described in detail with reference to the accompanying drawings. For convenience of description, three axes orthogonal to each other are illustrated as an X-axis, a Y-axis, and a Z-axis in the drawings. A direction along the X-axis is also referred to as “X-axis direction”, a direction along the Y-axis is also referred to as “Y-axis direction”, and a direction along the Z-axis is also referred to as “Z-axis direction”. In addition, the Z-axis extends in a vertical direction, the arrow side is also referred to as “upper”, and the opposite side is also referred to as “lower”. In addition, hereinafter, a plan view in the Z-axis direction is also simply referred to as “plan view”.

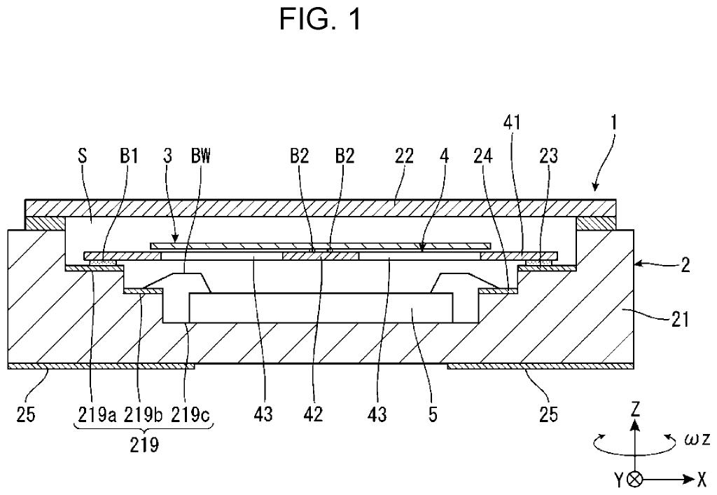

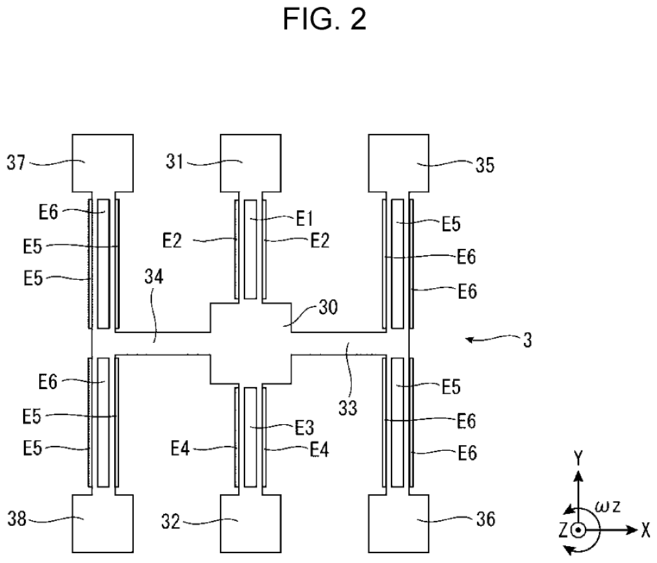

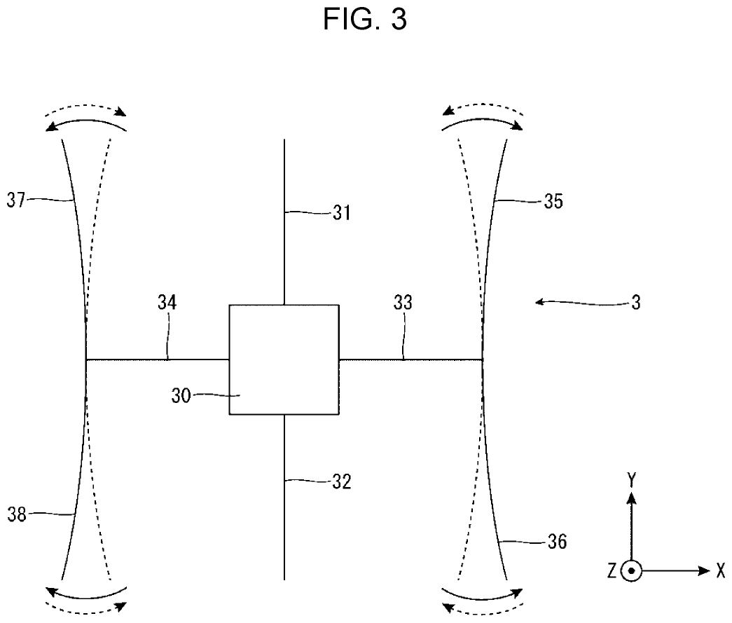

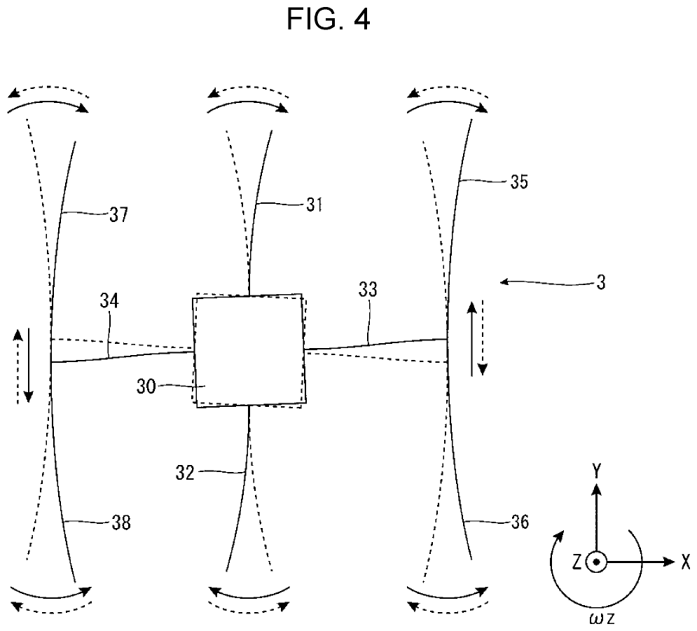

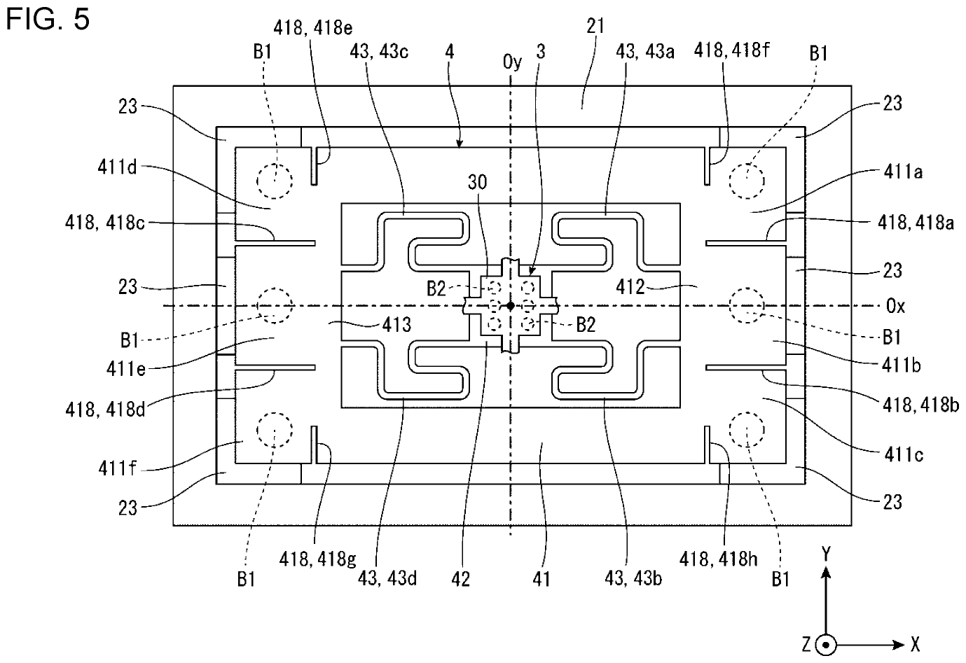

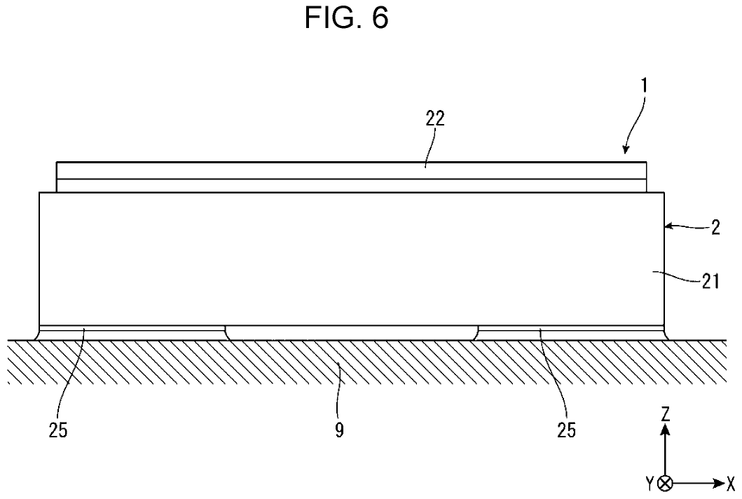

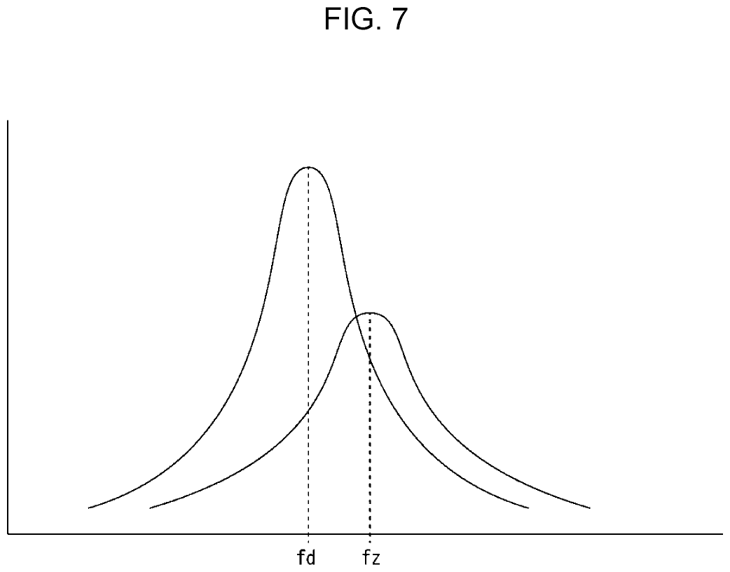

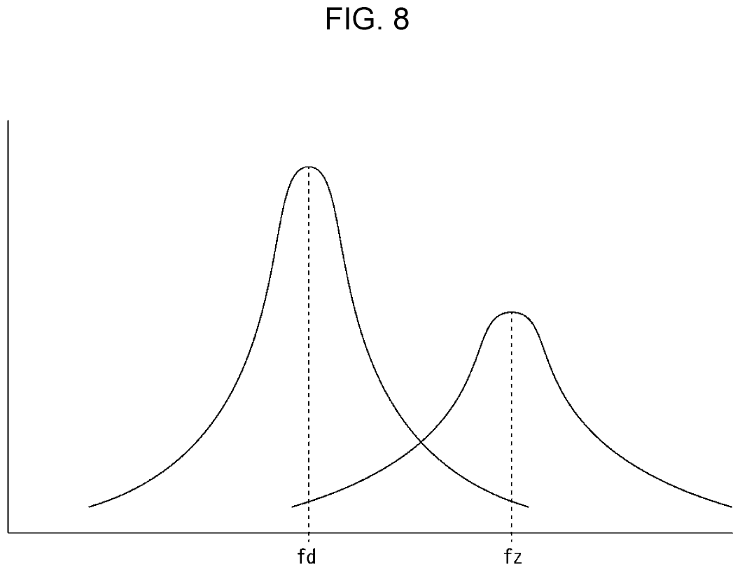

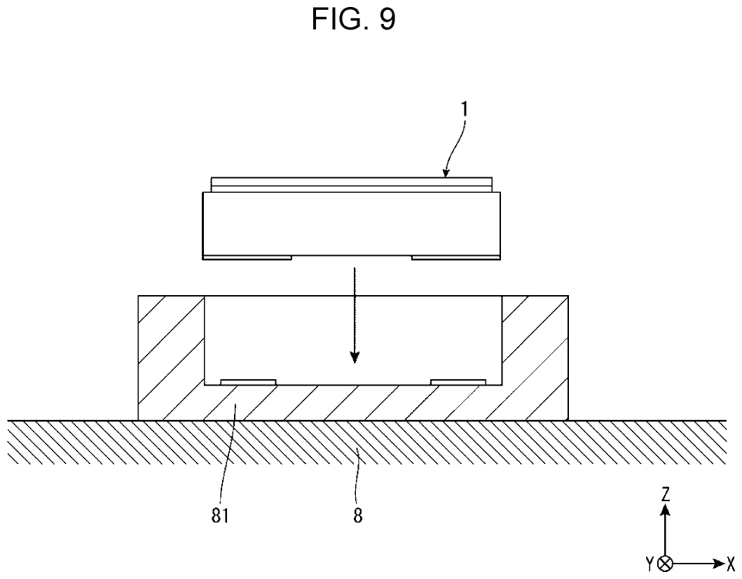

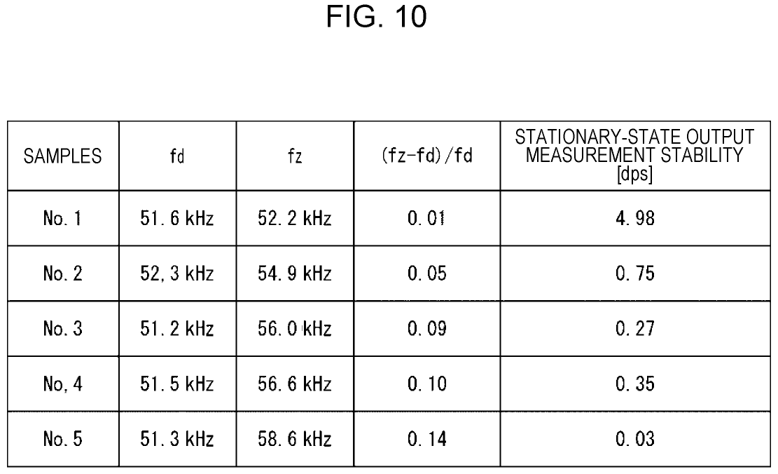

FIG. 1 is a cross-sectional view of a vibrator device according to a preferred embodiment. FIG. 2 is a top view of an angular velocity detector element of the vibrator device. FIG. 3 is a schematic diagram showing drive vibration of the angular velocity detector element. FIG. 4 is a schematic diagram showing detection vibration of the angular velocity detector element. FIG. 5 is a top view of a support substrate of the vibrator device. FIG. 6 is a view showing a mounting state of the vibrator device. FIGS. 7 and 8 are graphs showing a relationship between a frequency fd of drive vibration and a frequency fz of a Z-axis vibration mode. FIG. 9 is a cross-sectional view of a socket substrate for experiment. FIG. 10 is a table showing experimental results.

A vibrator device 1 shown in FIG. 1 is an angular velocity sensor that detects an angular velocity ωz around the Z-axis, and includes an angular velocity detector element 3 as a vibrator element to which the angular velocity ωz is applied, a support substrate 4 that supports the angular velocity detector element 3, a circuit element 5 that is electrically coupled to the angular velocity detector element 3, and a package 2 that accommodates these components.

### Package 2

As shown in FIG. 1, the package 2 includes a cavity-shaped base 21 having a recess portion 219 that is open in a top surface thereof, and a plate-shaped lid 22 that is bonded to the top surface of the base 21 and closes the opening of the recess portion 219. The package 2 has an internal space S, and the angular velocity detector element 3, the support substrate 4, and the circuit element 5 are accommodated in the internal space S so as to overlap each other in the Z-axis direction. In addition, the internal space S is hermetically sealed and is in a reduced pressure state, preferably in a state closer to vacuum. Thus, viscous resistance is reduced, and the angular velocity detector element 3 can be efficiently driven.

A constituent material of the base 21 is not particularly limited. For example, various ceramics such as aluminum oxide can be used. A constituent material of the lid 22 is not particularly limited, but a material with a linear expansion coefficient similar to that of the constituent material of the base 21 is preferable. For example, when the constituent material of the base 21 is a ceramic, an alloy such as Kovar is preferably used. In addition, a method of bonding the base 21 and the lid 22 is not particularly limited. For example, the base 21 and the lid 22 may be bonded to each other with a metallized layer or may be bonded to each other with an adhesive.

In addition, the recess portion 219 includes a first recess portion 219a that is open in the top surface of the base 21, a second recess portion 219b that is open in a bottom surface of the first recess portion 219a and has a smaller opening area than the first recess portion 219a, and a third recess portion 219c that is open in a bottom surface of the second recess portion 219b and has a smaller opening area than the second recess portion 219b. The circuit element 5 is bonded to a bottom surface of the third recess portion 219c with a bonding member, the support substrate 4 is bonded to the bottom surface of the first recess portion 219a with conductive bonding members B1, and the angular velocity detector element 3 is bonded to the support substrate 4 with conductive bonding members B2.

In addition, a plurality of internal terminals 23 are arranged on the bottom surface of the first recess portion 219a, a plurality of internal terminals 24 are arranged on the bottom surface of the second recess portion 219b, and a plurality of external terminals 25 are arranged on a bottom surface of the base 21. In addition, the plurality of internal terminals 24 include those electrically coupled to the internal terminals 23 through internal wiring lines (not shown) formed in the base 21 and those electrically coupled to the external terminals 25 through internal wiring lines. In addition, the internal terminals 23 are electrically coupled to the support substrate 4 through the bonding members B1, and the internal terminals 24 are electrically coupled to the circuit element 5 through bonding wires BW. The number and arrangement of the internal terminals 23 and 24 and the external terminals 25 are not particularly limited, and may be appropriately set depending on, for example, the number of terminals of the angular velocity detector element 3 and the circuit element 5.

### Angular Velocity Detector Element 3

The angular velocity detector element 3 is a quartz crystal vibrator element formed from a quartz crystal substrate. As shown in FIG. 2, the angular velocity detector element 3 includes a base portion 30 located at a center thereof, a pair of detection vibration arms 31 and 32 extending from the base portion 30 to both sides in the Y-axis direction, a pair of support arms 33 and 34 extending from the base portion 30 to both sides in the X-axis direction, a pair of drive vibration arms 35 and 36 extending from a tip end portion of one support arm 33 to both sides in the Y-axis direction, and a pair of drive vibration arms 37 and 38 extending from a tip end portion of the other support arm 34 to both sides in the Y-axis direction. The base portion 30 is bonded to the support substrate 4 with the bonding members B2.

In addition, the angular velocity detector element 3 includes, as electrodes, first detection signal electrodes E1 arranged on both main surfaces of the detection vibration arm 31, first detection ground electrodes E2 arranged on both side surfaces of the detection vibration arm 31, second detection signal electrodes E3 arranged on both main surfaces of the detection vibration arm 32, second detection ground electrodes E4 arranged on both side surfaces of the detection vibration arm 32, drive signal electrodes E5 arranged on both main surfaces of the drive vibration arms 35 and 36 and both side surfaces of the drive vibration arms 37 and 38, and drive ground electrodes E6 arranged on both side surfaces of the drive vibration arms 35 and 36 and both main surfaces of the drive vibration arms 37 and 38.

Such an angular velocity detector element 3 detects the angular velocity ωz in the following manner. When a drive signal is applied between the drive signal electrodes E5 and the drive ground electrodes E6, as shown in FIG. 3, the drive vibration arms 35 and 36 and the drive vibration arms 37 and 38 perform flexural vibration in opposite phases in the X-Y plane (hereinafter, this state is also referred to as “drive vibration”). In this state, the vibrations of the drive vibration arms 35, 36, 37, and 38 are canceled out, and the detection vibration arms 31 and 32 do not substantially vibrate. When the angular velocity ωz is applied to the angular velocity detector element 3 in the drive vibration state, as shown in FIG. 4, the Coriolis force acts on the drive vibration arms 35, 36, 37, and 38 to excite flexural vibration in the Y-axis direction, and, in response to the flexural vibration, the detection vibration arms 31 and 32 perform flexural vibration in the X-axis direction (hereinafter, this state is also referred to as “detection vibration”).

A charge generated in the detection vibration arm 31 due to the detection vibration is extracted as a first output signal from the first detection signal electrodes E1, and a charge generated in the detection vibration arm 32 due to the detection vibration is extracted as a second output signal from the second detection signal electrodes E3. The angular velocity ωz is determined based on the first and second output signals.

### Support Substrate 4

As shown in FIG. 1, the support substrate 4 is bonded to the bottom surface of the first recess portion 219a with the bonding members B1. The support substrate 4 is located below the angular velocity detector element 3, and supports the angular velocity detector element 3 from below. That is, it can also be said that the support substrate 4 serves as a relay between the base 21 and the angular velocity detector element 3. The support substrate 4 has, for example, a function of absorbing or relieving a stress generated due to deformation of the base 21 or a thermal stress generated due to a difference in linear expansion coefficient so that the stress is less likely to be transmitted to the angular velocity detector element 3.

As shown in FIG. 5, the support substrate 4 includes a base portion 41 bonded to the base 21, a support portion 42 that supports the angular velocity detector element 3, and support arms 43 that couple the base portion 41 and the support portion 42. The support substrate 4 absorbs or relieves a stress transmitted from the base 21 to the base portion 41 by elastic deformation of the support arms 43 so that the stress is less likely to be transmitted to the angular velocity detector element 3. Therefore, the driving of the angular velocity detector element 3 is stabilized.

The base portion 41 has a rectangular frame shape in plan view in the Z-axis direction, and the support portion 42 and the support arms 43 are disposed inside the base portion 41. Since the base portion 41 has a frame shape, it is possible to increase the rigidity of the support substrate 4. In addition, since the support portion 42 and the support arms 43 are disposed inside the base portion 41, it is possible to effectively utilize the region inside the base portion 41 and to make the support substrate 4 smaller.

The base portion 41 includes six bonding regions 411a, 411b, 411c, 411d, 411e, and 411f, and is bonded to the bottom surface of the first recess portion 219a with the bonding members B1 in the bonding regions 411a, 411b, 411c, 411d, 411e, and 411f. Specifically, the base portion 41 includes a first bonding portion 412 and a second bonding portion 413 which are located on both sides in the X-axis direction and extend in the Y-axis direction. The three bonding regions 411a, 411b, and 411c are arranged side by side in the Y-axis direction in the first bonding portion 412, and the three bonding regions 411d, 411e, and 411f are arranged side by side in the Y-axis direction in the second bonding portion 413. The number of bonding regions corresponds to the number of electrodes of the angular velocity detector element 3.

In addition, the base portion 41 has slits 418 formed between the adjacent bonding regions. The slits 418 include a slit 418a that is located between the bonding regions 411a and 411b and extends from an outer edge of the base portion 41 to a negative side in the X-axis direction, and a slit 418b that is located between the bonding regions 411b and 411c and extends from the outer edge of the base portion 41 to the negative side in the X-axis direction. The slits 418 also include a slit 418c that is located between the bonding regions 411d and 411e and extends from the outer edge of the base portion 41 to a positive side in the X-axis direction, and a slit 418d that is located between the bonding regions 411e and 411f and extends from the outer edge of the base portion 41 to the positive side in the X-axis direction. Further, the slits 418 include a pair of slits 418e and 418f that are located between the bonding regions 411a and 411d and extend from the outer edge of the base portion 41 to a negative side in the Y-axis direction, and a pair of slits 418g and 418h that are located between the bonding regions 411c and 411f and extend from the outer edge of the base portion 41 to a positive side in the Y-axis direction.

Since the base portion 41 is elastically deformed such that the slits 418a to 418h are widened and narrowed, it is possible to absorb or relieve a stress transmitted from the base 21, in particular, a thermal stress generated due to a difference in linear expansion coefficient between the base 21 and the support substrate 4. That is, the stress transmitted from the base 21 can be effectively absorbed or relieved not only by the support arms 43 but also by the base portion 41. Therefore, the stress is less likely to be transmitted to the angular velocity detector element 3, and the driving of the angular velocity detector element 3 is stabilized.

However, the configuration of the slits 418 is not particularly limited. For example, the slits 418 may extend from an inner edge of the base portion 41, at least one slit may be omitted, or a slit may be added to another position. In addition, the slits 418 may be omitted.

In addition, the support arms 43 include four support arms 43a, 43b, 43c, and 43d that are arranged around the support portion 42 in a well-balanced manner. Specifically, the two support arms 43a and 43b are arranged on the positive side in the X-axis direction of the support portion 42, and the two support arms 43c and 43d are arranged on the negative side in the X-axis direction of the support portion 42. In addition, when an axis passing through the center of the support portion 42 along the X-axis is defined as a central axis Ox, and an axis passing through the center of the support portion 42 along the Y-axis is defined as a central axis Oy, the support arms 43a and 43b are arranged symmetrically with the support arms 43c and 43d with respect to the central axis Oy, and the support arms 43a and 43c are arranged symmetrically with the support arms 43b and 43d with respect to the central axis Ox. Therefore, the support portion 42 can be supported in a well-balanced and stable position.

In particular, in this embodiment, the support arms 43a, 43b, 43c, and 43d have a curved or bent shape halfway. Accordingly, for example, the support arms 43a, 43b, 43c, and 43d have a larger overall length and thus are more easily elastically deformed than those having a straight shape. Therefore, the stress transmitted from the base 21 can be absorbed or relieved more effectively.

The support portion 42 is disposed at the center of the support substrate 4. The base portion 30 of the angular velocity detector element 3 is bonded to the support portion 42 with the six conductive bonding members B2.

The support substrate 4 is formed from a quartz crystal substrate. Thus, a support substrate 4 with high mechanical strength can be obtained. In addition, since the support substrate 4 is formed from a quartz crystal substrate, as is the case with the angular velocity detector element 3, the linear expansion coefficient of the support substrate 4 can be made equal to that of the angular velocity detector element 3. Therefore, a thermal stress caused by a difference in linear expansion coefficient between the support substrate 4 and the angular velocity detector element 3 does not substantially occur, and the angular velocity detector element 3 is less likely to be subjected to stress. Therefore, the driving of the angular velocity detector element 3 is stabilized.

In particular, the support substrate 4 is formed from a Z-cut quartz crystal substrate, as is the case with the angular velocity detector element 3. The direction of the crystal axis thereof also coincides with that of the angular velocity detector element 3. Since quartz crystal has different linear expansion coefficients in the X-axis direction, the Y-axis direction, and the Z-axis direction, a thermal stress is less likely to occur between the support substrate 4 and the angular velocity detector element 3 when the support substrate 4 and the angular velocity detector element 3 are formed such that the cut angles thereof are identical and the directions of the crystal axes thereof are aligned with each other. Therefore, the angular velocity detector element 3 is even less likely to be subjected to stress, and the driving of the angular velocity detector element 3 is further stabilized.

The thickness of the support substrate 4 is not particularly limited, but is, for example, about 80 μm or more and about 120 μm or less. This makes it possible to ensure sufficient mechanical strength without excessively increasing the thickness of the support substrate 4.

The support substrate 4 is not limited to the above. For example, the support substrate 4 may be formed from a quartz crystal substrate having the same cut angle as that of the angular velocity detector element 3 but differ in crystal axis direction from the angular velocity detector element 3. In addition, the support substrate 4 may be formed from a quartz crystal substrate having a cut angle different from that of the angular velocity detector element 3. In addition, the support substrate 4 does not need to be formed from a quartz crystal substrate, and can be formed from, for example, a silicon substrate or a resin substrate.

In addition, although not shown, the support substrate 4 has six wiring lines that electrically couple the electrodes E1 to E6 of the angular velocity detector element 3 to the internal terminals 23 of the base 21. These wiring lines are coupled to the corresponding internal terminals 23 with the bonding members B1 at one end portion located on the bonding regions 411a to 411f of the base portion 41, and are coupled to the corresponding electrodes E1 to E6 with the bonding members B2 at the other end portion located on the support portion 42.

The bonding members B1 and B2 are not particularly limited as long as the bonding members B1 and B2 have both conductivity and bondability. In this embodiment, an Ag paste is used.

### Circuit Element 5

As shown in FIG. 1, the circuit element 5 is fixed to the bottom surface of the third recess portion 219c. The circuit element 5 mainly includes a drive circuit that applies a drive signal to drive the angular velocity detector element 3, and a detection circuit that performs a process of detecting the angular velocity ωz based on the first and second output signals from the angular velocity detector element 3.

The configuration of the vibrator device 1 has been described above. For example, as shown in FIG. 6, the vibrator device 1 is mounted on a mounting substrate 9 by reflow soldering. Here, the support substrate 4 has a Z-axis vibration mode that is a resonance mode in which vibration occurs in the Z-axis direction, that is, the thickness direction of the support substrate 4. As shown in FIG. 7, when a frequency fz of the Z-axis resonance mode is close to a drive frequency of the angular velocity detector element 3, that is, a frequency fd of drive vibration, the Z-axis vibration mode is excited in the support substrate 4 by the drive vibration of the angular velocity detector element 3, and the vibration in the Z-axis vibration mode leaks outside through the package 2 (hereinafter, also referred to as “leakage vibration”). Then, the leakage vibration is reflected by the mounting destination, that is, the mounting substrate 9 in the illustrated example, and is transmitted to the package 2 again. This vibration interferes with the angular velocity detector element 3 and varies the vibration state of the angular velocity detector element 3. In addition, since the degree and state of interference vary depending on the mounting state, an output signal of the angular velocity detector element 3 in a stationary state in which the angular velocity ωz is not applied changes greatly each time the vibrator device 1 is mounted on the mounting destination. In addition, for example, even when vibrator devices 1 are mounted on a plurality of mounting substrates 9 in the same manner, the output signal of the angular velocity detector element 3 in the stationary state varies depending on the difference between the individual vibrator devices 1 in the mounting state. Therefore, measurement reproducibility of stationary-state output deteriorates. Accordingly, as shown in FIG. 8, in the vibrator device 1, the frequency fd of the drive vibration and the frequency fz of the Z-axis resonance mode are sufficiently spaced apart from each other to have the following relationship, thereby improving the measurement reproducibility of the stationary-state output.

The frequency fz is a frequency in a state where the base portion 41 is bonded to the package 2, and the angular velocity detector element 3 is bonded to the support portion 42. The frequency fz can be calculated by simulation from, for example, the constituent material, the shape, the size, and the like of the support substrate 4. The frequency fz can also be determined by eigenvalue analysis using a laser Doppler vibrometer.

First, the case of fd<fz will be described. When fd<fz, the vibrator device 1 satisfies Inequality (1) below. The frequency fd of the drive vibration is generally set to about 50 kHz or higher and 56 kHz or lower, and it is not preferable to adjust the frequency fd in order to satisfy Inequality (1). Therefore, in the vibrator device 1, Inequality (1) is satisfied by adjusting the frequency fz of the Z-axis vibration mode. For example, the frequency fz has a high correlation with the thickness of the support substrate 4 and thus can be easily adjusted by changing the thickness of the support substrate 4. For example, when the support substrate 4 is made thicker, the rigidity of the support substrate 4 increases, and the frequency fz becomes higher. Conversely, when the support substrate 4 is made thinner, the rigidity thereof decreases, and the frequency fz becomes lower. The frequency fz can also be easily adjusted by changing the size of the bonding members B1. For example, when the diameter of the bonding members B1 is made larger, the bonding area with the support substrate 4 increases. Accordingly, the rigidity of the support substrate 4 increases, and the frequency fz becomes higher. Conversely, when the diameter of the bonding members B1 is made smaller, the bonding area with the support substrate 4 decreases. Accordingly, the rigidity of the support substrate 4 decreases, and the frequency fz thereof becomes lower.

$$0.05 < ( fz - fd ) / fd < 1 \qquad ( 1 )$$

That is, for example, when the frequency fd of the drive vibration is 50 kHz, the frequency fz of the Z-axis vibration mode is set to be higher than 52.5 kHz and lower than 100 kHz. When Inequality (1) is satisfied, the measurement reproducibility of the stationary-state output can be improved. Although it is sufficient to satisfy Inequality (1), it is particularly preferable to satisfy Inequality (2) below. Thus, the measurement reproducibility of the stationary-state output can be further improved.

$$0.1 < ( fz - fd ) / fd < 1 \qquad ( 2 )$$

Next, the effects of satisfying Inequalities (1) and (2) above will be described based on experimental examples. In this experiment, a socket substrate 8 as shown in FIG. 9 is used. The socket substrate 8 is provided with a socket 81 for mounting the vibrator device 1. When the vibrator device 1 is mounted on the socket 81, the vibrator device 1 is electrically coupled to the socket substrate 8, so that the vibrator device 1 can be driven.

In addition, as shown in FIG. 10, as the vibrator device 1, Sample No. 1 with a frequency fd of 51.6 kHz and a frequency fz of 52.2 kHz, Sample No. 2 with a frequency fd of 52.3 kHz and a frequency fz of 54.9 kHz, Sample No. 3with a frequency fd of 51.2 kHz and a frequency fz of 56.0KHz, Sample No. 4 with a frequency fd of 51.5 kHz and a frequency fz of 56.6 kHz, and Sample No. 5 with a frequency fd of 51.3 kHz and a frequency fz of 58.6 kHz were prepared. Each of these samples was inserted into and removed from the socket 81 five times at a room temperature of 25° C., the stationary-state output was measured each time for one second at 500 samples/second, and the average value thereof was calculated as the average value of the stationary-state output measurement. Further, a difference between the maximum and the minimum of the average values of the stationary-state output measurement five times was calculated as stationary-state output measurement stability (dps).

As can be seen from FIG. 10, for Sample No. 1, in which (fz−fd)/fd=0.01, the stationary-state output measurement stability was 4.98, and the stationary-state output measurement stability was found to be low. In contrast, for Sample Nos. 2, 3, 4, and 5, the stationary-state output measurement stability was found to be sufficiently high. Among these samples, for Sample No. 5, the stationary-state output measurement stability was particularly high. As described above, the measurement reproducibility of the stationary-state output can be improved when Inequality (1) above is satisfied, and the measurement reproducibility of the stationary-state output can be further improved when Inequality (2) above is satisfied.

Here, the measurement reproducibility of the stationary-state output increases as the frequency fz is spaced apart from the frequency fd, but resonance with the second order harmonic of the frequency fd may occur when the frequency fz is excessively spaced apart from the frequency fd. When the stationary-state output of the vibrator device 1 deteriorates at a temperature at which the resonance occurs, a dip occurs in the temperature characteristics of the stationary-state output. In this way, the temperature drift of the stationary-state output caused by resonance between the n-th order harmonic of the frequency fd and the frequency fz is referred to as “nω dip”. In the vibrator device 1, the upper limit of (fz−fd)/fd is set to less than 1, that is, fz<2fd. Thus, the no dip can be effectively avoided.

Next, the case of fd>fz will be described. When fd>fz, the vibrator device 1 satisfies Inequality (3) below.

$$0.05 < ( fd - fz ) / fd < 0.9 \qquad ( 3 )$$

That is, for example, when the frequency fd of the drive vibration is 50 kHz, the frequency fz of the Z-axis vibration mode is set to be higher than 5 kHz and lower than 47.5 kHz. When Inequality (3) is satisfied, the measurement reproducibility of the stationary-state output can be improved. Although it is sufficient to satisfy Inequality (3), it is particularly preferable to satisfy Inequality (4) below. Thus, the measurement reproducibility of the stationary-state output can be further improved.

$$0.1 < ( fd - fz ) / fd < 0.9 \qquad ( 4 )$$

Even when fd>fz, the results are similar to those of the experimental examples where fz>fd, and the measurement reproducibility of the stationary-state output can be improved.

Here, the measurement reproducibility of the stationary-state output increases as the frequency fz is spaced apart from the frequency fd; however, if the frequency fz is spaced apart from the frequency fd by making the support substrate 4 thinner, the support substrate 4 may become too thin when the frequency fz is excessively spaced apart from the frequency fd. As a result, the support substrate 4 may have insufficient mechanical strength and may thus be easily damaged. Therefore, in the vibrator device 1, the upper limit of (fd−fz)/fd is set to 0.9. Thus, the mechanical strength of the support substrate 4 can be sufficiently ensured.

The vibrator device 1 has been described above. As described above, the vibrator device 1 includes, when three axes orthogonal to each other are defined as the X-axis, the Y-axis, and the Z-axis, the angular velocity detector element 3 as a vibrator element that performs drive vibration in a direction along the X-Y plane defined by the X-axis and the Y-axis, and the support substrate 4 that supports the angular velocity detector element 3. When fd>fz, 0.05<(fd−fz)/fd<0.9, and when fd<fz, 0.05<(fz−fd)/fd<1, where fd is the frequency of the drive vibration of the angular velocity detector element 3, and fz is the frequency of the Z-axis vibration mode that is the vibration mode along the Z-axis of the support substrate 4. Thus, the frequency fz is sufficiently spaced apart from the frequency fd, and the measurement reproducibility of the stationary-state output of the vibrator device 1 can be improved.

In addition, as described above, it is preferable in the vibrator device 1 that when fd>fz, 0.1<(fd−fz)/fd<0.9, and when fd<fz, 0.1<(fz−fd)/fd<1. Thus, the frequency fz is sufficiently spaced apart from the frequency fd, and the measurement reproducibility of the stationary-state output of the vibrator device 1 can be improved.

In addition, as described above, the angular velocity detector element 3 is an angular velocity detector element that detects the angular velocity ωz around the Z-axis, and includes the drive vibration arms 35, 36, 37, and 38 that perform the drive vibration and the detection vibration arms 31 and 32 that perform detection vibration in response to the angular velocity ωz around the Z-axis. Thus, the vibrator device 1 can be used as an angular velocity sensor that detects the angular velocity ωz.

In addition, as described above, the support substrate 4 includes the base portion 41, the support portion 42 that supports the angular velocity detector element 3, and the support arms 43 that couple the base portion 41 and the support portion 42. With such a configuration, the support arms 43 absorb or relieve a stress, and the stress is less likely to be transmitted from the base portion 41 to the support portion 42. Thus, the stress is less likely to be transmitted to the angular velocity detector element 3, and the driving of the angular velocity detector element 3 is stabilized.

In addition, as described above, the base portion 41 has a frame shape, and the support portion 42 is disposed inside the base portion 41. Since the base portion 41 has a frame shape, it is possible to increase the rigidity of the support substrate 4. In addition, since the support portion 42 is disposed inside the base portion 41, it is possible to effectively utilize the region inside the base portion 41 and to make the support substrate 4 smaller.

In addition, as described above, the vibrator device 1 includes the package 2 that accommodates the angular velocity detector element 3 and the support substrate 4, and the base portion 41 is bonded to the package 2. Thus, the angular velocity detector element 3 is supported by the package 2 with the support substrate 4 therebetween. For this reason, the stress transmitted from the package 2 is absorbed or relieved by the support substrate 4, and is less likely to be transmitted to the angular velocity detector element 3. Therefore, the driving of the angular velocity detector element 3 is stabilized.

In addition, as described above, the base portion 41 includes the plurality of bonding regions 411a to 411f bonded to the package 2 and the slits 418a to 418h formed between the adjacent bonding regions 411a to 411f. Thus, the base portion 41 is easily elastically deformed, and the base portion 41 can also absorb or relieve the stress transmitted from the package 2. Therefore, the stress is less likely to be transmitted to the angular velocity detector element 3, and the driving of the angular velocity detector element 3 is further stabilized.

Although the vibrator device according to the present disclosure has been described above based on the illustrated embodiments, the present disclosure is not limited thereto, and the configuration of each portion can be replaced with any configuration having a similar function. In addition, any other component may be added to the present disclosure. In addition, the embodiments may be appropriately combined.

In addition, although the angular velocity detector element 3 is configured to detect the angular velocity ωz around the Z-axis in the embodiment described above, the angular velocity detector element 3 is not limited thereto and may be configured to detect, for example, an angular velocity around the X-axis. In this case, the angular velocity detector element 3 may have, for example, an H-shaped configuration including a base portion, a pair of detection vibration arms extending side by side from the base portion to one side in the X-axis direction, and a pair of drive vibration arms extending side by side from the base portion to the other side in the X-axis direction. In addition, the angular velocity detector element 3 may be configured to detect an angular velocity around the Y-axis. In this case, similarly, the angular velocity detector element 3 may have, for example, an H-shaped configuration including a base portion, a pair of detection vibration arms extending side by side from the base portion to one side in the Y-axis direction, and a pair of drive vibration arms extending side by side from the base portion to the other side in the Y-axis direction. In addition, the angular velocity detector element 3 is not limited to an element having vibration arms that perform tuning fork type vibration, but may be, for example, a comb-shaped element that is formed by MEMS fabrication and that detects an angular velocity based on a change in electrostatic capacitance.

In addition, although the angular velocity detector element 3 is located above the support substrate 4 in the embodiment described above, the angular velocity detector element 3 is not limited thereto and may be, for example, located below the support substrate 4 and supported so as to be suspended from the support substrate 4.

In addition, although the vibrator device 1 includes the circuit element 5 in the embodiment described above, the circuit element 5 may be omitted. In addition, in the embodiment described above, the vibrator element is the angular velocity detector element 3, and the vibrator device 1 is an angular velocity sensor; however, the vibrator device 1 is not limited thereto. For example, the vibrator element may be a vibrator element for an oscillator, and the vibrator device 1 may be an oscillator or a vibrator.

What is claimed is:

1. A vibrator device comprising, when three axes orthogonal to each other are defined as an X-axis, a Y-axis, and a Z-axis:
a vibrator element that performs drive vibration in a direction along an X-Y plane defined by the X-axis and the Y-axis; and
a support substrate that supports the vibrator element, wherein
when fd>fz, 0.05<(fd−fz)/fd<0.9, and
when fd<fz, 0.05<(fz−fd)/fd<1,
where fd is a frequency of the drive vibration of the vibrator element, and fz is a frequency of a Z-axis vibration mode that is a vibration mode along the Z-axis of the support substrate.

2. The vibrator device according to claim 1, wherein
when fd>fz, 0.1<(fd−fz)/fd<0.9, and
when fd<fz, 0.1<(fz−fd)/fd<1.

3. The vibrator device according to claim 1, wherein the vibrator element is an angular velocity detector element that detects an angular velocity around the Z-axis, and includes
a drive vibration arm that performs the drive vibration, and
a detection vibration arm that performs detection vibration in response to the angular velocity around the Z-axis.

4. The vibrator device according to claim 1, wherein the support substrate includes a base portion, a support portion that supports the vibrator element, and a support arm that couples the base portion and the support portion.

5. The vibrator device according to claim 4, wherein the base portion has a frame shape, and the support portion is disposed inside the base portion.

6. The vibrator device according to claim 5, further comprising a package that accommodates the vibrator element and the support substrate, wherein
the base portion is bonded to the package.

7. The vibrator device according to claim 6, wherein the base portion includes a plurality of bonding regions bonded to the package and a slit formed between the adjacent bonding regions.
